(19) United States
(12) Patent Application Publication
(10) Pub. No.: US 2007/0276825 A1
(43) Pub. Date: Nov. 29, 2007

(54) QUERY REUSE THROUGH RECOMMEND PARAMETER FLEXIBILITY

(76) Inventors: Richard D. Dettinger, Rochester, MN (US); Janice R. Glowacki, Rochester, MN (US); Daniel P. Kolz, Rochester, MN (US); Padma S. Rao, Rochester, MN (US); Marci L. Sperber, Rochester, MN (US); Shannon E. Wenzel, Colby, WI (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/380,772

(22) Filed: Apr. 28, 2006

(51) Int. Cl. G06F 17/30

(52) U.S. Cl. 707/6

(57) ABSTRACT

Embodiments of the present invention provide methods and systems for increasing the flexibility and reusability of parameterized queries. A user may be allowed to select and run a predefined query. If the query is a parameterized query, the user may be prompted to input one or more parameters. Embodiments of the invention allow the user to recommend a parameter that retrieves maximum or minimum results for the query instead of specifying a parameter. In response to such a user selection, a predefined parameter may be inserted as a parameter for the query. Alternatively, the query may be modified by changing or removing one or more query conditions to achieve the desired results.

### BACKGROUND OF THE INVENTION

1. Field of the Invention

The present invention generally relates to a data processing, and more specifically to increasing the flexibility and the reusability of parameterized queries.

2. Description of the Related Art

Querying a database to retrieve information may be a critical function for most businesses. A database may contain information collected and processed by the business over time. Such information may provide the business with critical data to aid decision making, planning, program implementation, control, etc. The ability to quickly and efficiently retrieve such critical data may provide a business with a competitive advantage in its respective market. For example, critical data collected and processed over time may indicate a shift in consumer expectations related to products or services provided by the business. By adjusting its products and services to the changing consumer expectations, the business may become more profitable.

Different queries may be written to perform different functions and retrieve different data contained in a database. For example, a hospital may maintain a table 100 in a database to record the vital signs of a patient, as illustrated in FIG. 1. Queries may be written to retrieve information recorded in the table based on various criteria. For example, the exemplary query shown below may be written to retrieve the records of patients with a body temperature greater than 100° F.
SELECT * FROM Table 1
WHERE Temperature >100
   When run against the database table 100 of FIG. 1, the above illustrated query will return the patient records for patients 1, 2 and 9. However, if a floor nurse wishes to retrieve the records of patients with a body temperature greater than 97° F., she may have to rewrite the above query with the number 97 in place of the number 100. Therefore, each time the nurse wishes to retrieve data based on different criteria, the query may have to be rewritten. However, the floor nurse is unlikely to have the time or skills necessary to rewrite complex queries.

Furthermore, writing many different queries can become very expensive. Therefore, there is a need to minimize the use of unique queries and maximize the flexibility and reusability of existing queries. One method to increase the flexibility and reusability of queries is to use parameterized queries. A parameterized query may prompt a user for input representing a parameter in the query. The user input may be inserted at parameter markers within the query before the query is run. For example, in the above query, a parameter marker may be placed at the number indicating the lower limit for body temperature. The floor nurse may be prompted to specify the lower limit prior to running the query. Therefore, by allowing the user to use the same query to define different parameter values instead of writing a separate query for each desired parameter value, the reusability and flexibility of the query can be increased and lay users can be shielded from the complexities of query development.

However, one problem with parameterized queries occurs when the user may not know the specific value of a parameter that will yield the desired result. For example, a floor nurse may want to retrieve information about all patients on her floor regardless of the parameter value. This would not be possible with the above parameterized query because the user may not know the threshold value that will return the desired results. Furthermore, even if the user was able to determine the threshold value, such threshold value is likely to change as data is continuously input in the database.

Therefore, what is needed is improved methods and systems to improve the flexibility and reusability of parameterized queries.

### SUMMARY OF THE INVENTION

The present invention generally relates to data processing, and more specifically to increasing the flexibility and the reusability of parameterized queries.

One embodiment of the invention provides a method of processing parameterized queries. The method generally comprises providing a parameterized query having one or more specified output fields for which data is to be returned and at least one condition containing a parameter marker configured to take an assigned value selected from a plurality of possible values and receiving a selection from one of a plurality of possible selections. The selections comprise specifying a value for the parameter marker selected from the plurality of possible values, and requesting predefined desired results characteristic without specifying a value for the parameter marker. If the selection does not specify a value for the parameter marker, the method comprises modifying the query based on a predefined query modification process corresponding to the requested predefined desired results characteristic, whereby the parameterized query is transformed into a non-parameterized executable query.

Another embodiment of the invention provides a computer readable storage medium containing a program which, when executed, performs operations for processing parameterized queries. The operations generally comprise providing a parameterized query having one or more specified output fields for which data is to be returned and at least one condition containing a parameter marker configured to take an assigned value selected from a plurality of possible values and receiving a selection from one of a plurality of possible selections. The selections comprise comprising specifying a value for the parameter marker selected from the plurality of possible values, and requesting predefined desired results characteristic without specifying a value for the parameter marker. If the selection does not specify a value for the parameter marker, the method comprises modifying the query based on a predefined query modification process corresponding to the requested predefined desired results characteristic, whereby the parameterized query is transformed into a non-parameterized executable query.

Yet another embodiment of the invention provides a system comprising a memory containing at least one application and a processor communicably connected to the memory. The processor, when executing the application is configured to provide a parameterized query having one or more specified output fields for which data is to be returned and at least one condition containing a parameter marker configured to take an assigned value selected from a plurality of possible values and receive a selection from one of a plurality of possible selections. The selections comprise specifying a value for the parameter marker selected from the plurality of possible values, and requesting a predefined desired results characteristic without specifying a value for the parameter marker. If the selection does not specify a value for the parameter marker, the processor is configured to modify the query based on a predefined query modification process corresponding to the requested predefined desired results characteristic, whereby the parameterized query is transformed into a non-parameterized executable query.

A further embodiment of the invention provides a method of processing parameterized queries. The method generally comprises providing a parameterized query having one or more specified output fields for which data is to be returned and at least one condition containing a parameter marker configured to take an assigned value selected from a plurality of possible values, receiving a selection of one of at least two possible selections for which a specified number of results are returned for a non-parameterized executable form of the parameterized query without specifying a value for the parameter marker, and in response to the selection, modifying the parameterized query based on a predefined query modification process corresponding to the selection, whereby the parameterized query is transformed into a non-parameterized executable query.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is an illustration of an exemplary data structure containing data relating to vital signs of patients in a hospital.

FIG. 2 is an illustration of an exemplary system according to an embodiment of the invention.

FIG. 3 is another illustration of a data structure containing data of patients in a hospital.

FIG. 4 is an illustration of an exemplary GUI screen that prompts a user for parameter values to be included in a parameterized query, according to an embodiment of the invention.

FIG. 5 is a flow diagram of exemplary operations performed to run a predefined query according to one embodiment of the invention.

FIGS. 6A-6E illustrate exemplary operations performed on an exemplary parameterized query to retrieve maximum and minimum results for the query.

FIGS. 7A-7E illustrate exemplary operations performed on an exemplary parameterized query to retrieve maximum and minimum results for the query.

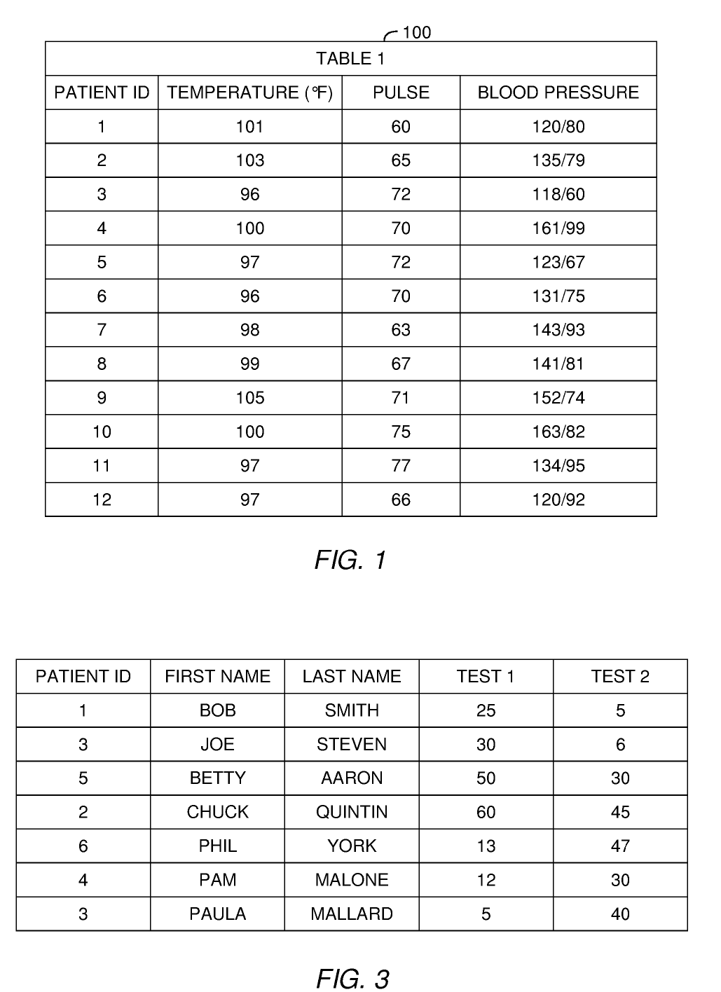

### DETAILED DESCRIPTION OF THE PREFERRED EMBODIMENTS

Embodiments of the present invention provide methods, articles of manufacture and systems for increasing the flexibility and reusability of parameterized queries. A user may be allowed to select and run a predefined query. If the query is a parameterized query, the user may be prompted to input one or more parameters values. Embodiments of the invention allow the user to recommend a parameter that retrieves maximum or minimum results for the query instead of specifying a parameter. In response to such a user selection, a predefined parameter may be inserted as a parameter for the query. Alternatively, the query may be modified by changing or removing one or more query conditions to achieve the desired results.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

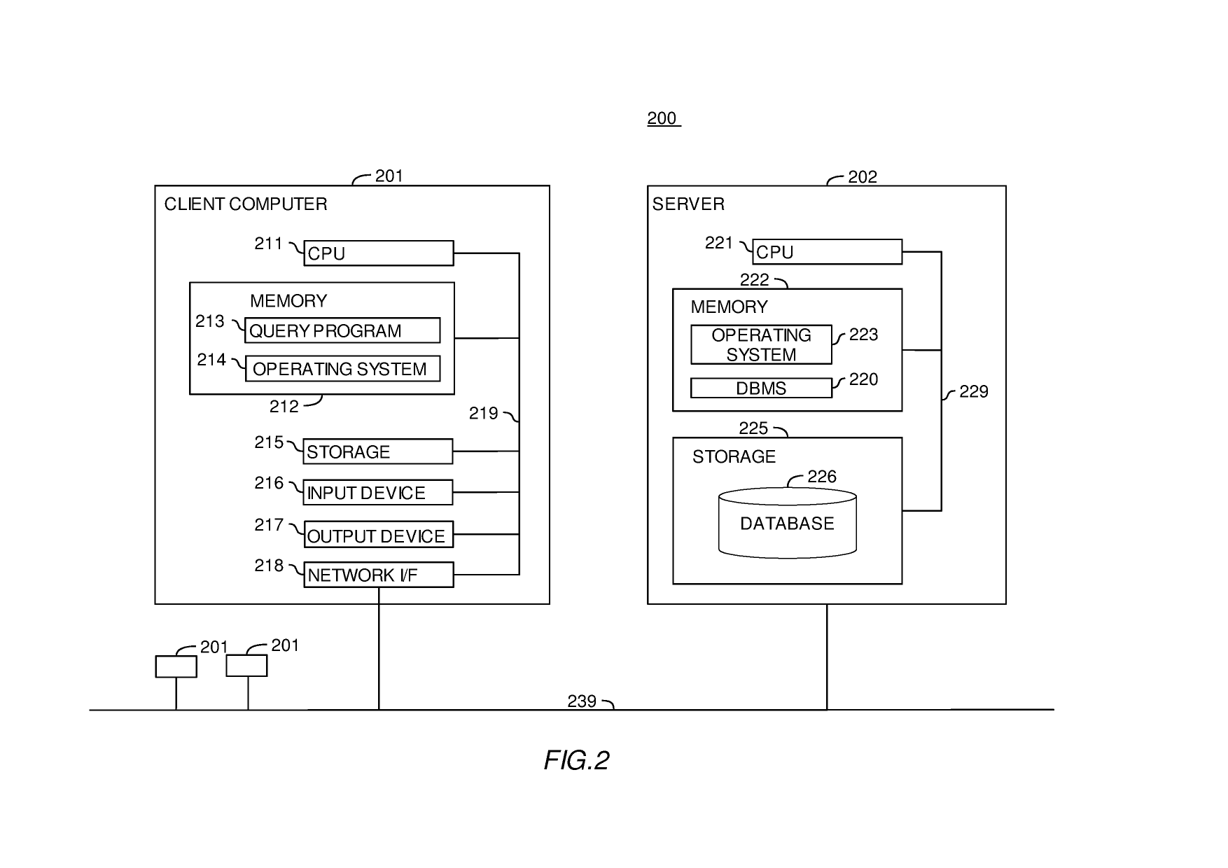

One embodiment of the invention is implemented as a program product for use with a computer system such as, for example, the network environment 200 shown in FIG. 2 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

### Exemplary System

FIG. 2 depicts a block diagram of a networked system 200 in which embodiments of the present invention may be implemented. In general, the networked system 200 includes a client (e.g., user's) computer 201 (three such client computers 201 are shown) and at least one server 202. The client computers 201 and server 202 are connected via a network 239. In general, the network 239 may be a local area network (LAN) and/or a wide area network (WAN). In a particular embodiment, the network 239 is the Internet.

The client computer 201 includes a Central Processing Unit (CPU) 211 connected via a bus 219 to a memory 212, storage 215, an input device 216, an output device 217, and a network interface device 218. The input device 216 can be any device to give input to the client computer 201. For example, a keyboard, keypad, light-pen, touch-screen, track-ball, or speech recognition unit, audio/video player, and the like could be used. The output device 217 can be any device to give output to the user, e.g., any conventional display screen. Although shown separately from the input device 216, the output device 217 and input device 216 could be combined. For example, a display screen with an integrated touch-screen, a display with an integrated keyboard, or a speech recognition unit combined with a text speech converter could be used.

The network interface device 218 may be any entry/exit device configured to allow network communications between the client computers 201 and server 202 via the network 239. For example, the network interface device 218 may be a network adapter or other network interface card (NIC).

Storage 215 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 212 and storage 215 could be part of one virtual address space spanning multiple primary and secondary storage devices.

The memory 212 is preferably a random access memory such as a Dynamic Random Access Memory (DRAM) sufficiently large to hold the necessary programming and data structures of the invention. While memory 212 is shown as a single entity, it should be understood that memory 212 may in fact comprise a plurality of modules, and that memory 212 may exist at multiple levels, from high speed registers and caches to lower speed but larger DRAM chips.

Illustratively, the memory 212 contains an operating system 213. Illustrative operating systems, which may be used to advantage, include Linux and Microsoft's Windows®. More generally, any operating system supporting the functions disclosed herein may be used.

The memory 212 is also shown containing a query program 214 that, when executed by CPU 211, provides support for querying a server 202. In one embodiment, the query program 214 includes a web-based Graphical User Interface (GUI), which allows the user to display Hyper Text Markup Language (HTML) information. More generally, however, the query program may be a GUI-based program capable of rendering the information transferred between the client computer 201 and the server 202.

The server 202 may be physically arranged in a manner similar to the client computer 201. Accordingly, the server 202 is shown generally comprising a CPU 221, a memory 222, and a storage device 225, coupled to one another by a bus 229. Memory 222 may be a random access memory sufficiently large to hold the necessary programming and data structures that are located on the server 202.

The server 202 is generally under the control of an operating system 223 shown residing in memory 222. Examples of the operating system 223 include IBM OS/400®, UNIX, Microsoft Windows®, and the like. More generally, any operating system capable of supporting the functions described herein may be used.

The memory 222 further includes a database management system (DBMS) 220. DBMS 220 may include any necessary software for receiving and processing queries. The software may comprise a plurality of instructions that are resident at various times in various memory and storage devices in the computer system 200. Exemplary software includes query parsers and optimizers and query engines. When read and executed by one or more processors 221 in the server 202, DBMS 220 may cause the computer system 200 to perform the steps necessary to execute steps or elements embodying the various aspects of the invention. The query interface 224 (and more generally, any requesting entity, including the operating system 223) is configured to issue queries against a database 226 (shown in storage 225).

The database 226 is representative of any collection of data regardless of the particular physical representation. By way of illustration, the database 226 may be organized according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of data. Queries issued by client 201 may be executed against database 226. Appropriate query results may then be returned to client 201. Although only one database is shown, it is contemplated that any number of databases may be provided.

### Flexible Parameterized Queries

A user may run query program 214 to issue queries against a database 226 in server 202. As described above, query program 214 may provide a HTML display to allow the user to select and run queries. A selected query may be dispatched to server 202. The query may be received by query interface 224 at server 202, which may access database 226 and provide results of the query to client computer 201 over network 239.

In some embodiments, the query program 214 may be configured to prompt the user for parameters of a predefined parameterized query. For example, a floor nurse at a hospital may launch query program 214 and select a predefined parameterized query (it is contemplated that predefined parameterized queries may be saved as persistent query objects on either the client computer 201, the sever computer 202, or some other location). The floor nurse may proceed to input parameters into the predefined parameterized query and issue the query to database 226 to retrieve data relating to patients resident in her respective floor of the hospital.

FIG. 3 shows an exemplary data structure 300 against which the predefined parameterized query may be issued. Illustrative fields contained in data structure 300 include patient identification (ID) 301, patient's first name 302, patient's last name 303, and medical test 1 value 304 and medical test 2 value 305. The parameterized query may be configured to retrieve data from data structure 300. An exemplary parameterized query accessing data structure 300 is shown below:

SELECT “Patient ID”, “Last Name”, “Test1”
FROM TABLE300
WHERE Test1>?

The above query may be configured to retrieve data from a data structure (TABLE300) relating to patients with a Test1 value greater than a selected parameter value, as established by the WHERE clause of the query. The question mark (?) represents a parameter marker where the value of the parameter that may be inserted. The SELECT clause of the query describes the information (output fields) that is to be retrieved. As illustrated in the clause, the above described exemplary query retrieves the Patient ID, Last Name, and Test1 value for patients with a Test1 value greater than the user defined Test1 value.

In some instances the floor nurse may want to retrieve the Patient ID, Last name, and Test1 value for all the patients on his/her floor. This may require the floor nurse to write a separate query because the above described query requires the input of a parameter value which, depending on the selected value, may filter out some patients. Thus, in order to ensure that the above parameterized query actually returns all patients, regardless of their respective Test1 values, the floor nurse would need to know the lowest possible value for Test1, or at least the lowest recorded value in the table 300. Embodiments of the invention, however, allow the user to reuse a parameterized query without specifying a parameter, such that a maximum or minimum number of results are retrieved for the query. For example, embodiments of the invention may recommend a parameter value, or modify query conditions, so that a maximum or minimum number of results are retrieved for the parameterized query, thereby allowing the floor nurse to reuse the parameterized query to retrieve data for all patients on her floor. Parameter recommendation and query modification is described in greater detail below.

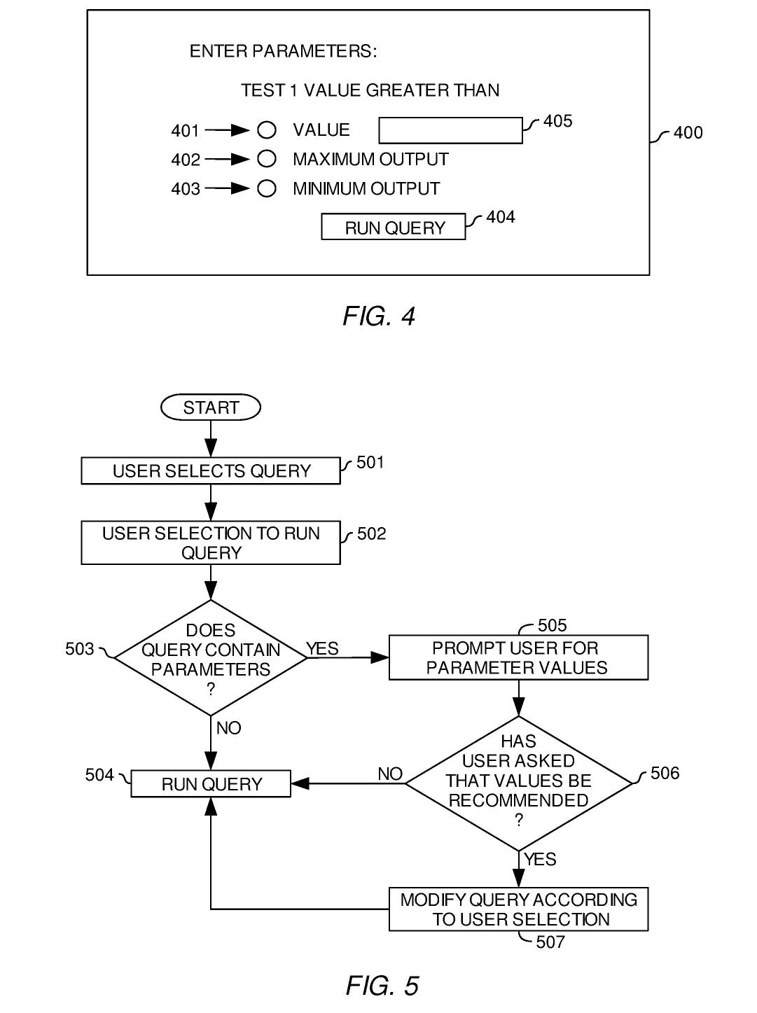

FIG. 4 illustrates an exemplary GUI screen 400, displayed to a user running the above query, according to an embodiment of the invention. As illustrated, GUI screen 400 may prompt a user to input a value for a parameter. For example, a user may select radio button 401 to select the option of providing a parameter value, and then enter the parameter value in text box 403. Alternatively, the user may also select either of radio buttons 402 or 403 to retrieve either maximum or minimum results using the parameterized query. After the user makes the appropriate selections, the user may click button 404 to run the query. One skilled in the art will recognize that GUI screen 400 is not limited to the graphical tools described above and may be implemented with any other known graphical tools. For example, check boxes may be used instead of the radio buttons. Drop down or combo boxes with a range of selections may be provided as an alternative to text box 403.

FIG. 5 illustrates exemplary operations that may be performed to run a query, according to an embodiment of the invention. The operations begin in step 501 by a user selecting a query. The query, for example, may be a parameterized or a non-parameterized query. In step 502, the user may make a selection to run the query. In response to the user selection to run the query, in step 503, it may be determined whether the query is a parameterized query or a non parameterized query. If the query is not a parameterized query, in step 504, the query may be run by issuing the query against a database.

If the query is a parameterized query, the user may be prompted for user selections to define the parameters of the query in step 505. User selections, for example, may specify a value for one or more parameters or, alternatively, request maximum or minimum results for the query (e.g., using the GUI of FIG. 4). In step 506, a determination is made as to whether the user has requested that a parameter be recommended. In other words, an inquiry is made as to whether the user has requested maximum or minimum results (e.g., by selecting either of radio buttons 402 or 403 of the GUI screen 400 of FIG. 4). If a parameter recommendation is not requested, the query may be run with the user defined parameters in step 504.

If a parameter recommendation is requested, the query may be modified in step 507 according to the user request. Modifying the query may include inserting a predetermined parameter value and/or modifying one or more query conditions. Query modification is described in greater detail below. The modified query may be run against the database in step 504.

### Parameter Recommendation

In some embodiments of the invention, a predefined parameter value may be inserted into a parameterized query if a user chooses not to specify a parameter value for a parameter marker. For example, the previously described exemplary query is shown again below:

### Exemplary Query 1

SELECT “Patient ID”, “Last Name”, “Test1”
FROM TABLE300
WHERE Test1>?

In FIG. 4, if the user requests that maximum results be displayed, a predefined value that would get the desired results may be inserted for the parameter before running the query. For example, Test1 may be defined as an integer value. The predefined value may be defined by the user for a given field or data type. For example, the user may define the maximum value of Test 1 to be a first integer value. Alternatively, the user may define a maximum integer value for all integer fields in the database. In other embodiments, the maximum and minimum values may be determined based on the particular platform on which the query is run. The predefined values for the query may therefore include the maximum (INT_MAX) and minimum (INT_MIN) possible integer values supported by the platform, for example, DB2, oracle, etc. One skilled in the art will recognize that similar maximum and minimum values may be defined by the user for a given field or by the platform for a given data type. Illustrative data types include short integer, long integer, floating point, double precision floating point, etc.

To return the maximum possible results for exemplary query 1, INT_MIN may be inserted as a value of the parameter. By inserting the smallest possible integer value supported by the system, a return of all, or a maximum number of values can be ensured. One skilled in the art will recognize that the parameter value inserted in the query may depend on an operator associated with the parameter. For example, if the query condition in the second line of exemplary query 1 is changed to Test1<?, INT_MAX may be inserted as a parameter value to return a maximum number of values. Exemplary query 1, modified to return maximum results is shown below:

### Exemplary Query 1 (Maximum Results)

SELECT “Patient ID”, “Last Name”, “Test1”
FROM TABLE300
WHERE Test1>INT_MIN

Similarly, by inserting the value of INT_MAX for the parameter value, a minimum number of results for the query may be retrieved. Exemplary query 1 modified to retrieve minimum results is shown below:

### Exemplary Query 1 (Minimum Results)

SELECT “Patient ID”, “Last Name”, “Test1”
FROM TABLE300
WHERE Test1>INT_MAX

### Query Condition Modification

In some embodiments, the conditions of a parameterized query may be altered to retrieve maximum or minimum results for the query. This approach may be used when the parameter inserted is of a string or Boolean type. Because such parameter types do not have maximum and minimum values the solution detailed in the previous section may not be useful. Therefore, embodiments of the invention may modify the query to achieve desired results.

FIG. 8 is a flow diagram of exemplary operations performed by the Database Management System (DBMS) 220 to process parameterized queries wherein the user has requested maximum or minimum values to be retrieved. Processing the parameterized queries, for example, may include inserting a parameter value and/or modifying the parameterized query by removing or replacing one or more query conditions based on the user's request.

The operations to process parameterized queries where the user has provided a request for maximum or minimum values may begin in step 801 by determining whether the parameter is a numerical parameter. Numerical parameters may include parameter of type integer, floating point, double, and the like. If the parameter is a numerical parameter, a parameter value may be inserted for the parameter based on the recommendation. In step 802, the DBMS may determine whether the user has requested maximum values to be displayed, or, in the alternative, requested minimum values. If maximum values are requested, in step 803, the DBMS may insert a value for the parameter to retrieve maximum results. For example, referring back to Exemplary Query 1, the value for INT_MIN was inserted as a parameter value to retrieve maximum results. On the other hand, if minimum results are requested, the DBMS may insert a value for the parameter that retrieves minimum results in step 804. For example, INT_MAX was inserted in Exemplary query 1 to retrieve minimum results.

If it is determined, in step 801, that the parameter is not a numerical parameter, one or more query conditions may be replaced or modified to retrieve results according to the user's request. For example, in step 805, if it is determined that the user has requested maximum results, one or more query conditions may be replaced or removed to retrieve maximum results in step 806. FIG. 9 further describes the operations described in step 806. On the other hand, if it is determined, in step 805, that the user has requested minimum results, one or more query conditions may be replaced or removed to retrieve minimum results in step 807. FIG. 10 further describes the operations described in step 807. Removing a query condition may include performing operations to remove one or more operators and query conditions such as those outlined in FIGS. 9, 10 and the examples below. Replacing a query condition may include placing a Boolean condition instead of the query condition as described above.

One skilled in the art will recognize that while insertion of a parameter value for numerical parameters is described in FIG. 8, query modification may be applied to numerical parameters as well. For example, in some embodiments the query condition containing the numerical parameter may be replaced with a Boolean condition. In other embodiments, one or more query conditions containing the numerical parameter may be removed from the query.

FIG. 9 is a flow diagram of exemplary operations performed by the DBMS to remove one or more query conditions to retrieve maximum results. The operations begin in step 901 by determining whether the parameter is an operand for an AND operator. If the parameter is an operand for an AND operator, the AND operator may be removed from the query in step 902. On the other hand, in step 903, if it is determined that the operand is an operator for an OR operator, all ancestor OR operators may be removed until an AND operator is encountered in step 904. In step 905, after removing the one or more query conditions, if an operator in the query is left with a missing operand, the operator may be replaced with the existing other operand in step 906.

FIG. 10 is a flow diagram of exemplary operations performed by the DBMS to remove one or more query conditions to retrieve minimum results. The operations begin in step 1001 by determining whether the parameter is an operand for an OR operator. If the parameter is an operand for an OR operator, the OR operator may be removed from the query in step 1002. On the other hand, in step 1003, if it is determined that the operand is an operator for an AND operator, all ancestor AND operators may be removed until an OR operator is encountered in step 1004. In step 1005, after removing the one or more query conditions, if an operator in the query is left with a missing operand, the operator may be replaced with the existing other operand in step 1006.

The operations described in FIGS. 9 and 10 are further explained by means of the following examples. An exemplary query that may require query condition modification is shown below:

### Exemplary Query 2

SELECT “Patient ID”, “Last Name”, “Test1”
FROM TABLE300
WHERE Test1>30 OR (Test2>25 AND “Last Name” LIKE “%?%”)

Exemplary query 2 may retrieve the Patient ID, Last Name and Test1 value of patients whose Test1 value is greater than 30. Exemplary query 2 also retrieves the data of patients whose Test2 value is greater than 25 and whose last names contain a string defined by the parameter marker (?).

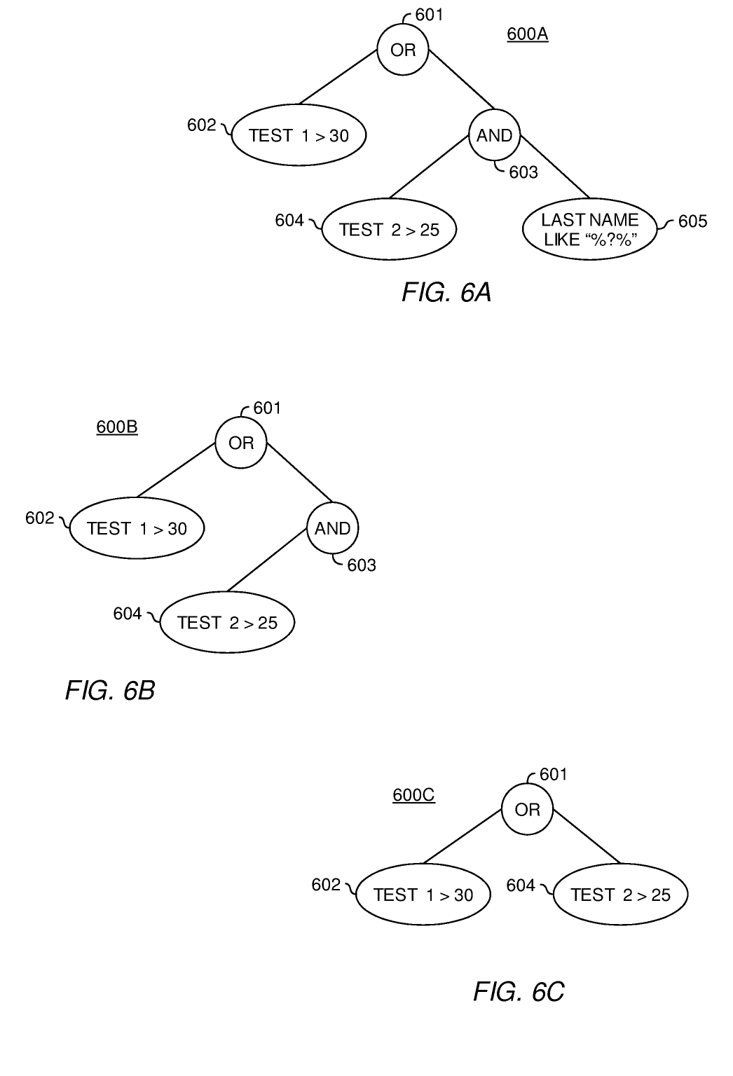

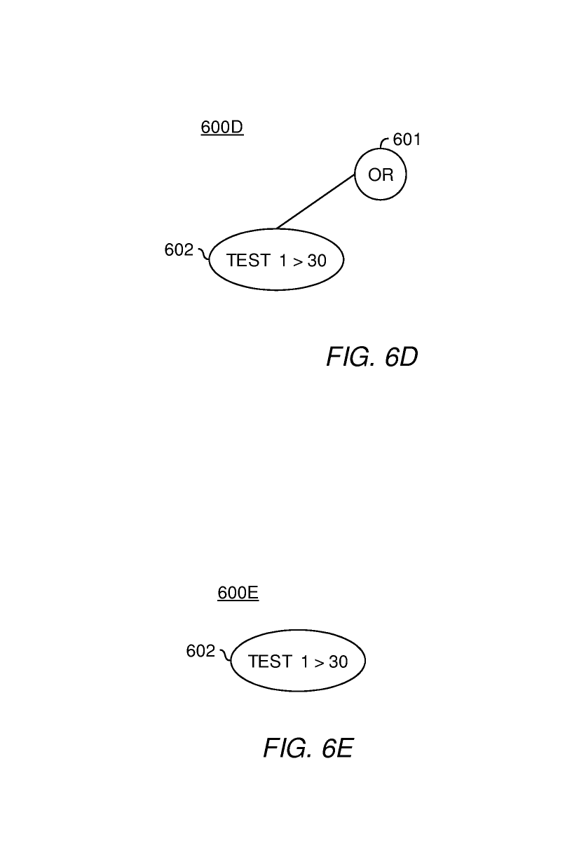

In one embodiment of the invention, one or more operators and their respective one or more operands may be removed from the query to achieve desired results. The operators and operands may be organized as a tree of operators, wherein each operator has operand children. An illustration of the operator tree 600A for Exemplary query 2 is shown in FIG. 6A.

In some embodiments, if an AND operator has a child containing the parameter or if the child of the AND operator is a sub-tree containing a parameter, the query conditions in the child or the sub-tree may be removed from the query to retrieve maximum results. Referring to the tree for exemplary query 2 in FIG. 6A, the tree contains an AND operator 603 with a child containing a parameter, namely the last name string comparison 605. Therefore, applying the above-stated rule, the condition in 605 may be removed from the query.

The status of the query tree for exemplary query 2 after removing the query condition for the string comparison is shown in FIG. 6B. As illustrated in FIG. 6B, removal of a query condition may leave a missing node in the tree. A missing node, for example, may include operators such as AND or OR which should have two children, but only have one child as a result of the removed query condition. In some embodiments, a missing node may be fixed by replacing the operator with the existing child of the operator. For example, in FIG. 6B, AND operator 603 may be replaced with its one existing child 604. FIG. 6C illustrates the status of the query tree after replacing the AND operator.

The resulting query, described by tree 600C in FIG. 6C, to retrieve maximum results for exemplary query 2 is shown below:

### Exemplary Query 2 (Maximum Results)

SELECT “Patient ID”, “Last Name”, “Test1”
FROM TABLE300
WHERE Test1>30 OR Test2>25

In another embodiment, the exemplary query 2 is modified to return the minimum number of results, as will now be described with reference to FIGS. 6A, 6D and 6E. If an AND operator has a child containing the parameter, all ancestor AND operators may be removed going up the tree until an OR operator is encountered to retrieve minimum results. Referring to the tree for exemplary query 2 in FIG. 6A, the tree contains an AND operator 603 with a child containing a parameter, namely the last name string comparison 605. Therefore, applying the above stated rule, AND operator 603 may be removed from the query. Moving up the tree from AND operator 603, the next higher operator encountered is an OR operator. Therefore, no more operators need to be removed.

The status of the query tree for exemplary query 2 after removing the query condition for the string comparison is shown in FIG. 6D. Because OR operator 601 has only one child in FIG. 6D, a missing node exists. Therefore, OR operator 601 may be replaced with the Test1 condition 602. The resulting tree is shown in FIG. 6E. The resulting query, described by the tree in FIG. 6E, to retrieve minimum results for exemplary query 2 is shown below:

### Exemplary Query 2 (Minimum Results)

SELECT “Patient ID”, “Last Name”, “Test1”
FROM TABLE300
WHERE Test1>30

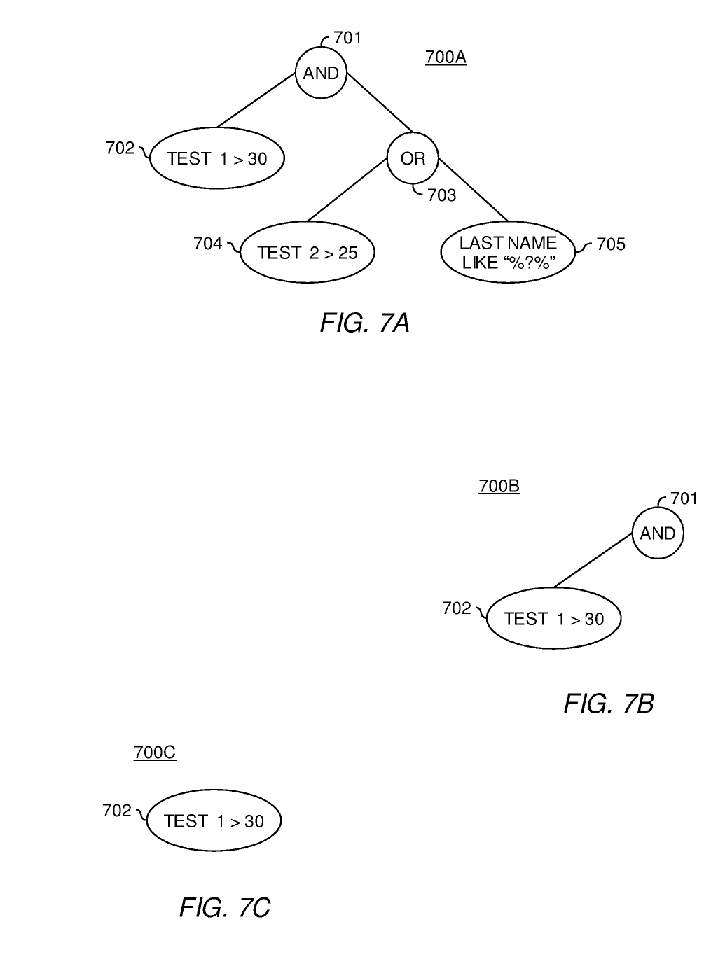

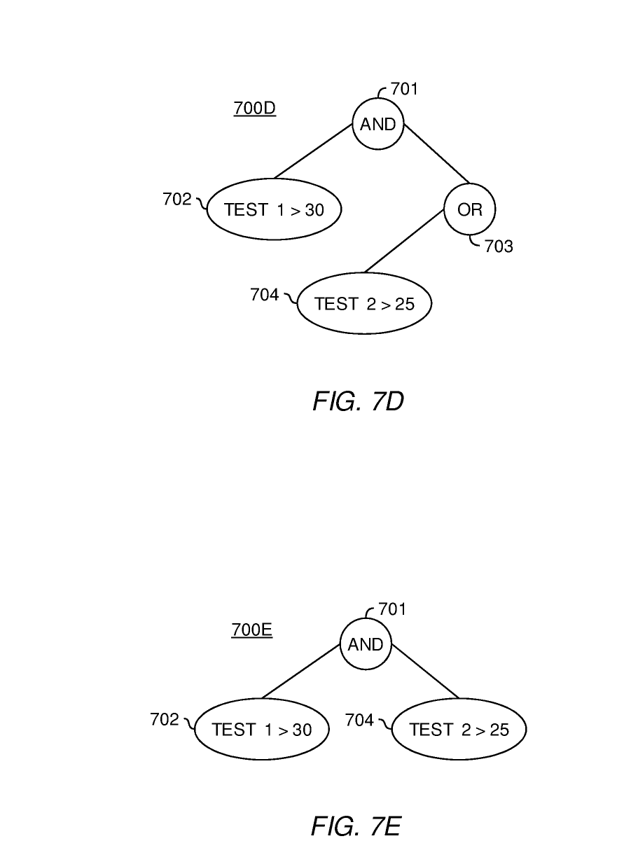

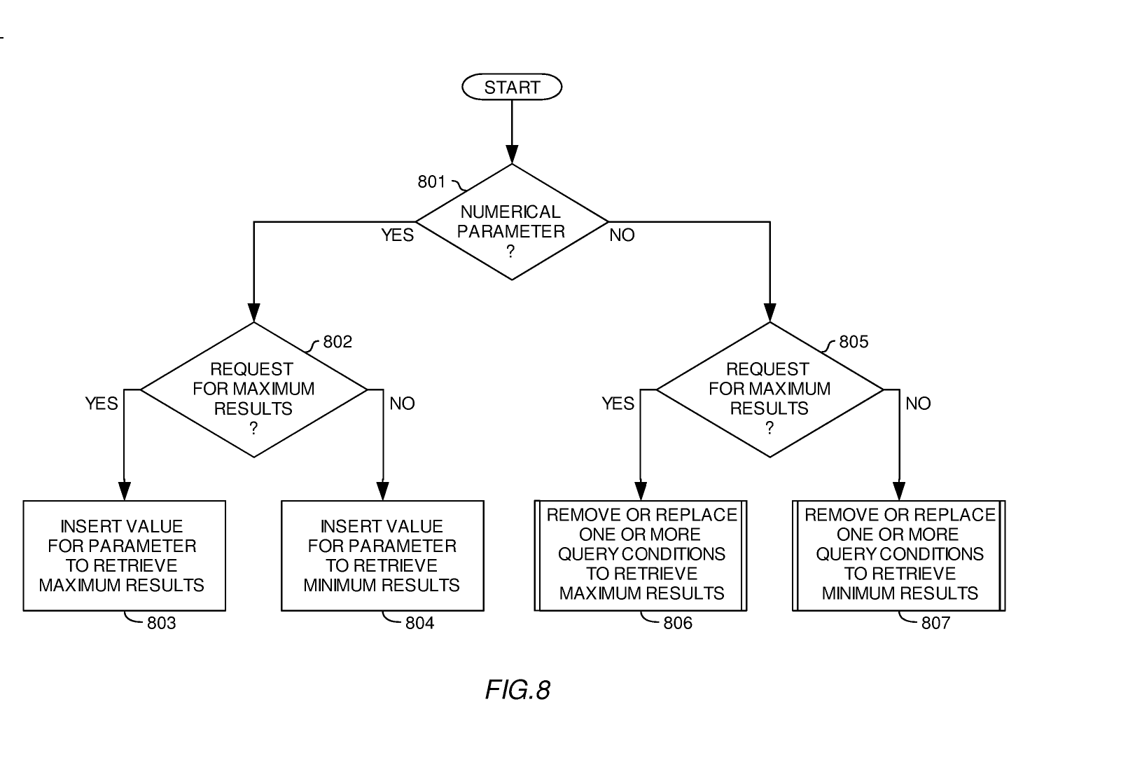

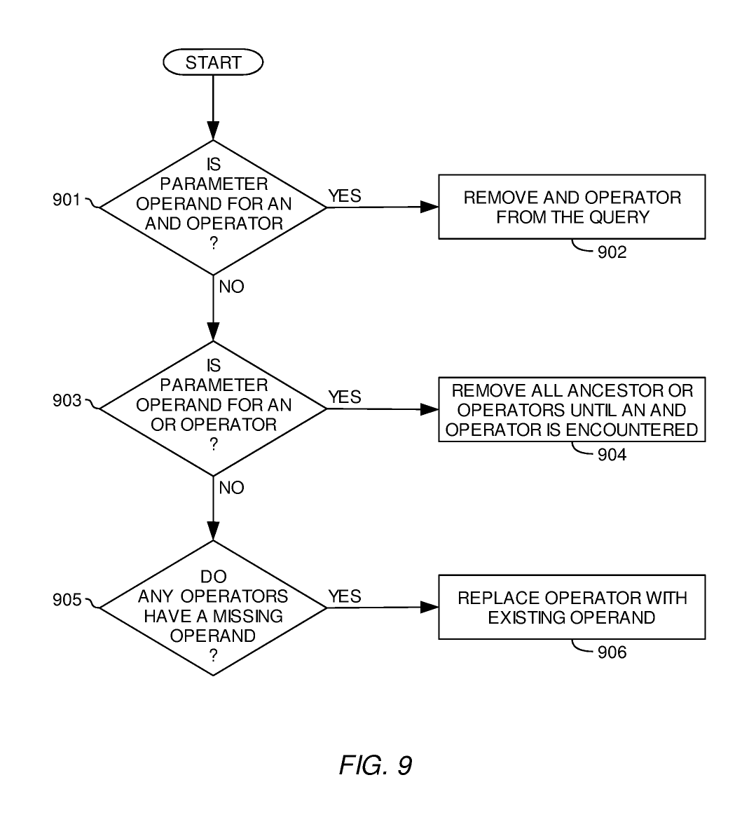

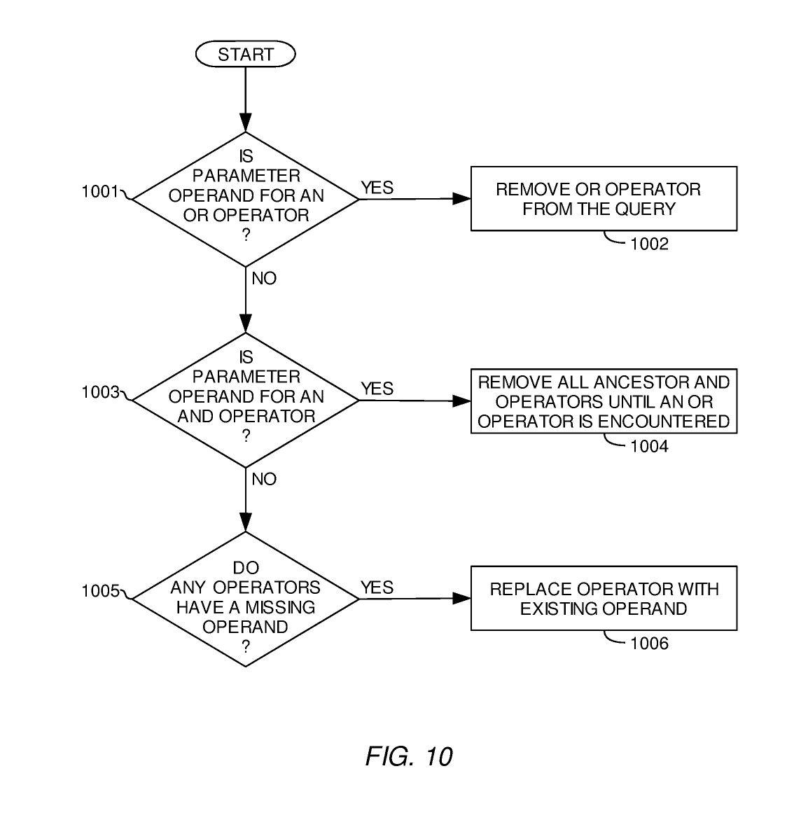

Another exemplary query that may require query condition modification is shown below. An illustration of the operator tree for Exemplary query 3 is shown in FIG. 7A.

### Exemplary Query 3

SELECT “Patient ID”, “Last Name”, “Test1”
FROM TABLE300
WHERE Test1>30 AND (Test2>25 OR “Last Name” LIKE “%?%”)

Exemplary query 3 may retrieve the Patient ID, Last Name and Test1 value of patients whose Test1 value is greater than 30 if the patient's Test2 value is greater than 25 or if the patient's last name contains a string defined by the parameter marker (?).

One embodiment for retrieving the maximum results is described with respect to FIGS. 7A-7C. According to the illustrated embodiment, if an OR operator has a child containing the parameter, all ancestor OR operators may be removed going up the tree until an AND operator is encountered to retrieve maximum results. Referring to the tree for exemplary query 3 in FIG. 7A, the tree contains an OR operator 703 with a child containing a parameter, namely the last name string comparison 705. Therefore, applying the above stated rule, OR operator 703 may be removed from the query. Moving up the tree from OR operator 703, the next higher operator encountered is an AND operator. Therefore, no more operators need to be removed.

The status of the query tree for exemplary query 3 after removing the query condition for the string comparison is shown in FIG. 7B. Because AND operator 701 has only one child in FIG. 7B, a missing node exists. Therefore, AND operator 701 may be replaced with the Test1 condition 702. The resulting tree is shown in FIG. 7C. The resulting query, described by the tree in FIG. 7C, to retrieve maximum results for exemplary query 3 is shown below:

### Exemplary Query 3 (Maximum Results)

SELECT “Patient ID”, “Last Name”, “Test1”
FROM TABLE300
WHERE Test1>30

An embodiment for retrieving the minimum results is now described with respect to FIGS. 7A, 7D and 7E. According to the illustrated embodiment, if an OR operator has a child containing the parameter or if the child of the OR operator is a sub-tree containing a parameter, the query conditions in the child or the sub-tree may be removed from the query to retrieve minimum results. Referring to the tree for exemplary query 3 in FIG. 7A, the tree contains an OR operator 703 with a child containing a parameter, namely the last name string comparison 705. Therefore, applying the above stated rule, the condition in 705 may be removed from the query.

The status of the query tree for exemplary query 3 after removing the query condition for the string comparison is shown in FIG. 7D. As illustrated in FIG. 7D, removal of a query condition may leave a missing node in the tree because OR operator 704 has only one child. Therefore, the missing node may be fixed by replacing OR operator 703 with it's existing child 704. FIG. 7E illustrates the status of the query tree after replacing the OR operator.

The resulting query, described by the tree in FIG. 7E, to retrieve minimum results for exemplary query 3 is shown below:

### Exemplary Query 3 (Minimum Results)

SELECT “Patient ID”, “Last Name”, “Test1”
FROM TABLE300
WHERE Test1>30 AND Test2>25

In some embodiments, a condition containing a parameter may be replaced with another condition to achieve the desired results. For example, to achieve maximum results, the parameterized condition may be replaced with a Boolean condition, the result of which is always true. Referring back to exemplary query 3, the parameterized last name string comparison condition may be replaces with a Boolean expression, the result of which is always true, to retrieve maximum results. For example, the parameterized condition in exemplary query 3 may be replaced with 1=1. Exemplary query 3 after the parameterized condition is replaced is shown below:

### Exemplary Query 3 (Maximum Results)

SELECT “Patient ID”, “Last Name”, “Test1”
FROM TABLE300
WHERE Test1>30 AND (Test2>25 OR 1=1 )

Similarly, to retrieve minimum results, a Boolean condition that is never true (i.e., no values satisfy the condition) may replace the parameterized condition to retrieve minimum results. For example, the parameterized condition in exemplary query 3 may be replaced with the Boolean condition 1=2 to retrieve minimum results. Exemplary query 3 after such replacement is shown below:

### Exemplary Query 3 (Minimum Results)

SELECT “Patient ID”, “Last Name”, “Test1”
FROM TABLE300
WHERE Test1>30 AND (Test2>25 OR 1=2)

One skilled in the art will recognize that the specific Boolean condition used is not relevant, rather, what is relevant is that the result of the Boolean condition be the same every time the query is run. Therefore, in the above query, any Boolean condition that always results in a true value may be used to replace the parameterized condition to retrieve maximum results. Similarly any Boolean condition that always results in a false value may be used to replace the parameterized condition to retrieve minimum results.

### Conclusion

By allowing a user to use a predefined parameterized query to retrieve maximum and minimum possible results based on the given parameters of the query, embodiments of the invention increase the reusability and flexibility of parameterized queries.

While the foregoing is directed to embodiments of the present invention, other and further embodiments of the invention may be devised without departing from the basic scope thereof, and the scope thereof is determined by the claims that follow.

What is claimed is:

1. A method of processing parameterized queries, comprising:
providing a parameterized query having one or more specified output fields for which data is to be returned and at least one condition containing a parameter marker configured to take an assigned value selected from a plurality of possible values;
receiving a selection from one of a plurality of possible selections, comprising:
specifying a value for the parameter marker selected from the plurality of possible values; and
requesting a predefined desired results characteristic without specifying a value for the parameter marker; and
if the selection does not specify a value for the parameter marker, modifying the query based on a predefined query modification process corresponding to the requested predefined desired results characteristic, whereby the parameterized query is transformed into a non-parameterized executable query.

2. The method of claim 1, wherein the at least one condition containing the parameter marker may be processed at query execution time according to one of two or more predefined query modification processes.

3. The method of claim 1, wherein if the selection does specify a value for the parameter marker, replacing the parameter marker with the specified value.

4. The method of claim 1, wherein requesting a predefined desired results characteristic without specifying a value for the parameter marker comprises one of:
requesting a maximum number of results for the query; and
requesting a minimum number of results for the query.

5. The method of claim 1, wherein modifying the query comprises inserting a predefined value for the parameter marker, wherein the predefined value is configured to retrieve results for the parameterized query based on the selection.

6. The method of claim 5, wherein the predefined value is determined based on parameter marker type and platform of the database in which the parameterized query is issued.

7. The method of claim 1, wherein modifying the query comprises removing one or more conditions of the parameterized query to retrieve results according to the selection.

8. The method of claim 7, wherein the one or more conditions comprises a parameterized condition wherein the parameterized condition comprises a field and an arithmetic operator relating the field and the parameter marker.

9. The method of claim 1, wherein modifying the query comprises replacing the condition containing the parameter marker with a Boolean condition that always returns the same value, wherein the Boolean condition is selected based on the selection from one of the plurality of possible selections.

10. A computer readable storage medium containing a program which, when executed, performs operations for processing parameterized queries, comprising:
providing a parameterized query having one or more specified output fields for which data is to be returned and at least one condition containing a parameter marker configured to take an assigned value selected from a plurality of possible values;
receiving a selection from one of a plurality of possible selections, comprising:
specifying a value for the parameter marker selected from the plurality of possible values; and
requesting a predefined desired results characteristic without specifying a value for the parameter marker; and
if the selection does not specify a value for the parameter marker, modifying the query based on a predefined query modification process corresponding to the requested predefined desired results characteristic, whereby the parameterized query is transformed into a non-parameterized executable query.

11. The computer readable medium of claim 10, wherein the at least one condition containing the parameter marker may be processed at query execution time according to one of two or more predefined query modification processes.

12. The computer readable medium of claim 10, wherein requesting a predefined desired results characteristic without specifying a value for the parameter marker comprises one of:
requesting a maximum number of results for the query; and
requesting a minimum number of results for the query.

13. The computer readable medium of claim 10, wherein modifying the query comprises inserting a predefined value for the parameter marker, wherein the predefined value is configured to retrieve results for the parameterized query based on the selection.

14. The computer readable medium of claim 13, wherein the predefined value is determined based on parameter marker type and platform of the database in which the parameterized query is issued.

15. The computer readable medium of claim 10, wherein modifying the query comprises removing one or more conditions of the parameterized query to retrieve results according to the selection.

16. The computer readable medium of claim 15, wherein the one or more conditions comprises a parameterized condition wherein the parameterized condition comprises a field and an arithmetic operator relating the field and the parameter marker.

17. The computer readable medium of claim 10, wherein modifying the query comprises replacing the condition containing the parameter marker with a Boolean condition that always returns the same value, wherein the Boolean condition is selected based on the selection from one of the plurality of possible selections.

18. A system, comprising:
a memory containing at least one application; and
a processor communicably connected to the memory which, when executing the application is configured to:
provide a parameterized query having one or more specified output fields for which data is to be returned and at least one condition containing a parameter marker configured to take an assigned value selected from a plurality of possible values;
receive a selection from one of a plurality of possible selections, comprising:
specifying a value for the parameter marker selected from the plurality of possible values; and
requesting a predefined desired results characteristic without specifying a value for the parameter marker; and
if the selection does not specify a value for the parameter marker, modify the query based on a predefined query modification process corresponding to the requested predefined desired results characteristic, whereby the parameterized query is transformed into a non-parameterized executable query.

19. The system of claim 18, wherein the processor is configured request a predefined desired results characteristic without specifying a value for the parameter marker by:
requesting a maximum number of results for the query; and
requesting a minimum number of results for the query.

20. The system of claim 18, wherein the processor is configured to modify the query by inserting a predefined value for the parameter marker, wherein the predefined value is configured to retrieve results for the parameterized query based on the selection.

21. The system of claim 18, wherein the processor is configured to modify the query by removing one or more conditions of the parameterized query to retrieve results according to the selection.

22. The system of claim 18, wherein the processor is configured to modify the query by replacing the condition containing the parameter marker with a Boolean condition that always returns the same value, wherein the Boolean condition is selected based on the selection from one of the plurality of possible selections.

23. A method of processing parameterized queries, comprising:
providing a parameterized query having one or more specified output fields for which data is to be returned and at least one condition containing a parameter marker configured to take an assigned value selected from a plurality of possible values;
receiving a selection of one of at least two possible selections for which a specified number of results are returned for a non-parameterized executable form of the parameterized query without specifying a value for the parameter marker; and
in response to the selection, modifying the parameterized query based on a predefined query modification process corresponding to the selection, whereby the parameterized query is transformed into a non-parameterized executable query.

24. The method of claim 23, wherein the received selection is one of:
a request for a maximum number of results for the query; and
a request for a minimum number of results for the query.

25. The method of claim 23, wherein modifying the parameterized query comprises traversing a tree structure representing the query and removing nodes depending on whether a logical connector in the traversed path of the tree structure is a Boolean AND or a Boolean OR.
